(19) United States
(12) Patent Application Publication
(10) Pub. No.: US 2002/0058132 A1
(43) Pub. Date: May 16, 2002

(54) Process for the production of a biaxially-oriented polyester film at high speeds and a film produced accordingly

(76) Inventors: Harald Mueller, Taunusstein (DE); Ursula Murschall, Nierstein (DE); Andreas Stopp, Ingelheim (DE); Cynthia Bennett, Alzey (DE)

Correspondence Address: PRO PAT, L.L.C., 2912 CROSBY ROAD, CHARLOTTE, NC, 28211-2815, US

(21) Appl. No.: 09/938,930

(22) Filed: Aug. 24, 2001

(30) Foreign Application Priority Data
Sep. 15, 2000 (DE) 100 45 603.0

(51) Int. Cl. B32B 27/36

(52) U.S. Cl. 428/220; 428/480

(57) ABSTRACT

The invention relates to a single-layered or multi-layered biaxially-oriented film, which mainly consists of a crystallizeable thermoplastic polyester and which can be produced at final speeds of 340 m/min or higher. According to the invention the film contains a polyester raw material with a specific electrical melt resistance lying within a range from 1.5×10⁷ to 30×10⁷ Ω×cm. The invention also relates to a process for the production of the film by way of extrusion, followed by stretching, thermofixing and winding it at high speeds of 340 m/min and higher.

### BACKGROUND OF THE INVENTION

1. Field of the Invention

The invention relates to a single-layered or multi-layered biaxially-oriented film, mainly made of a crystallizeable thermoplastic polyester.The film can be economically produced with a high surface quality and at speeds of more than 340 m/min. The invention also relates to a process for the production of the film and to its use.

2. Description of the Related Art

During the production of the films which have a thickness lying within the range from 0.5 to 350 μm plastic granulates are initially melted in an extruder and the extruded melts are then led through a flat-film die (slot die). The resulting, mainly amorphous prefilm emerging from the flat-film die is then placed on an internally cooled, polished high-grade steel take-off- and quenching roll, longitudinally and transversely stretched in relation to the machine direction after leaving the take-off roll, and thermofixed and wound up thereafter.

For the benefit of a stabilized placement of the prefilm on the take-off roll the state-of-the-art technology requires the application of additional forces to the prefilm in the area between the point at which the film exits the flat-film die and the point at which it is placed on the take-off roll. These additionally applied forces can be generated by blowing a stream of air out of an air knife at the prefilm, by spraying water into the nip of the prefilm prior to the point of application on the take-off roll, which causes a water film on the take-off roll, and by generating an electrical field by means of an electrode under high tension, with the field lines of the electrical field being directed towards the surface of the take-off roll. The additionally applied forces serve the purpose of removing, to the widest extent possible, the air which is enclosed between the surface of the take-off roll and the bottom side of the prefilm, i.e. that side of the prefilm facing the take-off roll, and which is underneath the nip of the prefilm, prior to placing the prefilm on the take-off roll, in order to obtain a stabilized placement of the prefilm on the surface of the roll by means of a given wrap angle. If this cannot be acomplished, air inclusions of a more or less voluminous nature, so-called pinning bubbles, may result, which can be found between the bottom side of the prefilm and the surface of the take-off roll, adversely affecting the smoothness of the surface and, thus, the quality of the prefilm previously cooled down on the take-off roll, and subsequently the quality of the biaxially-stretched film manufactured from it.

It is known that, in order to generate an electrical field a high-grade steel blade can be parallelly arranged to the surface of the take-off roll. For this purpose a 10 mm-wide portion of the steel blade is usually punched out or cut out from a metal blade which has a thickness of about 20 μm.

The german utility model G 9402027 describes a device for the production of films, especially thin films or thinnest films by means of a rotating roll, with which a plastically formable film, previously fed into a slot die, is transported and stretched. Between the roll and a steel band parallely arranged to the roll at a short distance, electrical tension is applied by which the film is placed on the roll. The steel band in this known device has a sharp longitudinal edge which is arranged right next to the roll and pointed directly to it. This sharp edge is, similar to a cutting edge, arranged at the tapered area of the steel band, which is hereby arranged right next to the roll at a distance of less than 6 mm. The center line of this tapered area is directly pointed towards the center point of the roll. The use of such a steel band electrode helps to improve the quality of the film.

As the final speeds during the film production are increased to a value beyond 340 m/min, an increased amount of pinning bubbles can be noticed. Increasing the electrical tension can counteract this development to a certain degree, but if the tensions applied are too high, electric arcing between the electrode and the quenching roll is the result. This leads to a severe defect within the film, namely an extremely thin area extending over the width of the film. The film breaks, which is very unfavourable from an economical point of view. The procedural window in the relation between pinning bubbles and electric arcing gets smaller as the speed is increased.

### SUMMARY OF THE INVENTION

It was the object of this invention to produce a biaxially-oriented polyester film with a thickness lying within the range from 1 to 20 μm at speeds of 340 m/min or more assuring a production process with a procedural window of a sufficient size.

This object is achieved by the use of polyester raw material for the production process with a specific electrical melt resistance lying within the range from 1.5×10⁷ to 30×10⁷ Ω×cm, preferably from 2×10⁷ to 10×10⁷ Ω×cm, especially preferred from 3×10⁷ to 6×10⁷ Ω×cm.

During the production of films with thicknesses of 1 to 20 μm at speeds of 340 m/min or more, a dramatically high amount of pinning bubbles is the result every time polyester raw material with an electrical melt resistance of 30×10⁷ Ω×cm or more is used. Increasing the electrical tension does reduce, but not eliminate the formation of pinning bubbles, since this leads to new electric arcings.

Should, however, the specific electrical melt resistance be below 1.5×10⁷ Ω×cm, the same problems previously described do occur.

It was completely surprising that biaxially-oriented polyester films with a thickness of 1 to 20 μm with final speeds of 340 m/min or more could be produced without pinning bubbles and without electric arcing when the polyester raw material used has a specific electrical melt resistance lying within the range from 1.5×10⁷ to 30×10⁷ Ω×cm, preferably from 2×10⁷ to 10×10⁷ Ω×cm, especially preferred from 3×10⁷ to 6×10⁷ Ω×cm.

The films according to the invention can be single- or multi-layered, they can have a symmetrical or an unsymmetrical structure, wherein differently composed polyesters, i.e. polyesters equipped with additional additives, respectively composed and non-composed polyesters, or polyesters of the same chemical compound but with a different molecular weight and a different viscosity are combined by way of coextrusion.

The film according to the invention mainly consists of a crystallizeable polyethylene terephthalate, of a crystallizeable polyethylene naphtalate (PEN), or mixtures thereof, wherein the polyesters have a specific electrical melt resistance lying within the range from 1.5×10⁷ to 30×10⁷ Ω×cm, according to the invention.

Crystallizeable polyethylene terephthalate or crystallizeable polyethylene naphthalate means

crystallizeable homopolymers

crystallizeable compounds

crystallizeable copolymers

crystallizeable recycled material

other variations of crystallizeable polyester.

Polyester can either be produced according to the ester interchange process, e.g. catalyzed by ester interchange catalysts such as Zn-, Mg-, Ca-, Mn-, Li-, or Ge-salts, or according to the direct ester process (PTA method), where antimone compounds are used as polycondensation catalysts and phosphorus compounds as stabilizers. The IV-value (intrinsic viscosity) of the polyesters preferably lies within the range from 0.5 to 1.0 dl/g.

Examples of polyesters are polycondensates made of terephthalic acid, isophtalic acid or2,6-naphthalene dicarboxylic acid containing glycols with 2 to 10 carbon atoms such as polyethylene terephthalate, polybutylene terephthalate, poly-1,4-cyclohexylene-dimethylene terephthalate, polyethylene-2,6-naphthalene dicarboxylate, polyethylene naphthalate/bibenzoate or polyethylene-p-hydroxy-benzoate.

The polyesters can be made of comonomer units of up to 50 mol %, especially of up to 30 mol %, where a variation of the glycol- and/or the acid component is possible. Among others the copolyesters can contain as acid components 4,4′-bibenzoic acid, adipic acid, glutaric acid, succinic acid, sebacic acid, phthalic acid, isophthalic acid, 5-Na-sulfoisophthalic acid or polyfunctional acids such as trimelitic acid.

It is important for the invention that the polyester raw material has a specific electrical melt resistance lying within the range from 1.5×10⁷ to 30×10⁷ Ω×cm.

The polyester films can be produced, in accordance with known methods, of a polyester raw material, optionally with other raw materials and/or further additives customarily used for making technical films at usual quantities of 0.1 to a maximum of 20% by weight, either as a monofilm or as multi-layered, optionally coextruded films with either equally or differently structured surfaces, wherein, for example, one surface is pigmented, and the other surface contains no pigment or less pigments. In that manner one or both surfaces of the films can be provided with a customary functional coating in accordance with known methods.

### DETAILED DESCRIPTION OF THE PREFERRED EMBODIMENTS

The preferred extrusion method for the production of the polyester film comprises extruding the melted polyester material through a flat-film die (slot die) and chilling it as a mainly amorphous prefilm on a quenching roll with the help of the electrical field of an electrode to which high tension of 4 to 8 kV has been applied. This film is reheated thereafter and stretched in the machine direction (MD) and in the transverse direction (TD), respectively TD and MD, respectively MD, TD and again MD and/or TD. The stretching temperatures are generally within the range from T_{g}+10 K to T_{g}+60 K (T_{g}=glass transition temperature), the length stretch ratio is usually within the range from 2 to 6, especially from 3 to 4.5, the transverse stretch ratio is within the range from 2 to 5, especially from 3 to 4.5, and the ratio of the optionally performed second length stretching is within the range from 1.1 to 3. As an option the first length stretching can be simultaniously performed with the transverse stretching (simultanious stretching). Subsequently the thermofixing of the film is done in a tenter frame at frame temperatures lying within the range from 150 to 250° C., especially from 170 to 240° C.

The speed of the film upon arrival at the winding machine is above 340 m/min. The fact that the film can be produced at high speeds, without electric arcing and free of pinning bubbles makes the production very economical. Due to its high quality the film is suitable for highly sophisticated applications, for example as carrier films for magnetic recording materials, high-quality wrapping films, capacitor films, films for applications in the metallizing field, to name just a few.

The measurement of the individual properties is performed in accordance with the following standards respectively methods.

Specific electrical melt resistance

The specific electrical melt resistance is determined according to the method by Brit. J. Appl. Phys. Volume 17, pages 1149-1154 (1966). The temperature of the melts (measuring temperature) is 285° C. and the resistance is observed immediately after applying a tension of 100 V.

Average thickness

The average thickness d_{F} of a film is determined by its weight at a given length, width and density. To be measured is the weight of a film strip prepared on the cutting table, taken from the middle of a sample which extends across the entire width of the roll. The value d_{F} is then determined by using the following formula:

$${d}_{F} ( μ m ) = \frac{m [ g ]}{l [ mm ] \cdot b [ mm ] \cdot d [ g / {cm}^{3} ]} \cdot {10}^{6}$$

with the following applying: m=mass of the pice of film

l=length of the sample

b=width of the sample

d=density of the examined material

d=1.395 g/cm³ for polyester

After the individual sample strips have been cut, their weight is determined with the help of an analytical scale, type Mettler PM 200 (maximum weight 200 g). A computer type HP Vectra ES/12 connected to the scale determins the average thickness using all necessary parameters.

IV-value (DCE)

The standard viscosity SV (DCE) is measured, in accordance with DIN 53726, in dichloro acetic acid.

The intrinsic viscosity (IV) is determined as follows, based on the standard viscosity:

IV(DCE)=6.67×10⁻⁴SV(DCE)+0.118.

Pinning bubbles

In order to examine the film for pinning bubbles a 10 cm wide film strip is analyzed while being led over the entire width of the original roll past the monochromatic light of a sodium arc lamp (wave length 590 nm) in front of a black background. The pinning bubbles on the surface of the film are then transmitted to a screen with a 120-fold magnification via a video camera and assessed.

A film free of pinning bubbles has a homogenous unstructured surface.

A film with pinning bubbles looks slightly dull and has a surface covered with an innumerable number of the smallest of bubbles (spots). The number of bubbles respectively spots is≧5000 per 100 cm² of film.

### Example 1

Chips made of polyethylene terephthalate containing an amount of 3000 ppm of CaCO₃-particles with an average particle diameter of 0.7 μm, measured according to the sedigraphic method (K135 of KOSA, Germany), with an SV value of 780 and a specific electrical melt resistance of 4.2×10⁷ Ω·cm were dried to a residual humidity of 50 ppm at a temperature of 160° C. and put through an extruder thereafter. By extrusion and subsequent sequential orientation in MD and TD, a single-layered film with a thickness of 13 μm was produced at a final speed of 380 m/min. The length stretch ratio was 4.6. The film was wound up thereafter to result in a master roll with a running length of 40000 m.

The placement of the melt film on the quenching roll was done by way of electrostatic pinning. The tension applied to the electrode was 5.6 kV.

No pinning bubbles did develop, nor electric arcing, which could have led to film breaks. The running stability was good.

### Example 2

By way of coextrusion technology a three-layered ABA film was produced, with B representing the base layer with a thickness of 11 μm and A representing the cover layers, with a thickness of 1 μm each, arranged on both sides of the base layer B.

The polyethylene terephthalate for the base layer had a SV-value of 810 and a specific melt resistance of 3.6×10⁷ Ω×cm (FL2CV, Toray, France). The same raw material FL2CV of Toray was used for the cover layers. By way of masterbatch technology the raw material for the cover layers was provided, with an amount of 5000 ppm of CaCO₃-particles with an average particle diameter of 0.7 μm, measured according to the sedigraphic method. The final speed during the film production was about 400 m/min. The tension applied to the electrode as in example 1 was 5.8 kV. The length stretch ratio was 4.6.

As in Example 1 no pinning bubbles did develop, nor electric arcing, which could have led to film breaks. The running stability was good.

### Comparative Example 1

Example 1 was repeated. In contrast to example 1, however, a PET raw material with a specific electrical melt resistance of 82×10⁷ Ω×cm (RT 49 of KOSA, Germany) was used. Regardless of the tension setting used, it was impossible to place the melt film emerging from the slot die on the quenching roll without pinning bubbles developping and without electric arcing as a result, thus leading to film breaks.

### Comparative Example 2

Example 2 was repeated. In contrast to Example 2 a PET raw material with a specific electrical melt resistance of 0.95×10⁷ Ω×cm (Saehan A 9203, Korea) was used for the base layer B and the cover layers A. Regardless of the tension setting used, it was impossible to place the melt film emerging from the slot die on the quenching roll without pinning bubbles developping and without electric arcings as a result, thus leading to film breaks.

The results of all the films produced according to the examples and the comparative examples are summarized and depicted in the following table.

TABLE 1

| | | Specific | | | | | | |
|---|---|---|---|---|---|---|---|---|
| | IV- | electrical | Length | Final | Tension | | | |
| | value | resistance | stretch | speed | applied | Pinning | Electric | Running |
| | [dl/g] | [Ω · cm] | ratio | [m/min] | [kV] | bubbles | arcing | stability |
| Example 1 | 0,6 | 4,2 × 10⁷ | 4,0 | 380 | 5,6 | none | no | good |
| Example 2 | 0,66 | 3,6 × 10⁷ | 4,1 | 400 | 5,3 | none | no | good |
| Compara- | 0,6 | 82 × 10⁷ | 4,0 | 380 | 4 to 8 | Placement | yes | bad |
| tive | | | | | | w/o pinning | | |
| example 1 | | | | | | bubbles | | |
| Compara- | 0,66 | 0,95 × 10⁷ | 4,1 | 400 | 4 to 8 | Placement w/o | yes | bad |
| tive | | | | | | pinning | | |
| example 2 | | | | | | bubbles | | |
| | | | | | | impossible | | |

We claim:

1. Single-layered or multi-layered biaxially-oriented film, mainly made of a crystallizeable thermoplastic polyester and produceable at final speeds of 340 m/min and higher, wherein the film contains a polyester raw material whith a specific electrical melt resistance which lies within a range from 1.5×10⁷ to 30×10⁷ Ω×cm.

2. Film, as claimed in claim 1, wherein the film contains a polyester raw material with a specific electrical melt resistance which lies within a range from2×10⁷ to 10×10⁷ Ω×cm.

3. Film, as claimed in claim 1, wherein the thickness of the film is within a range from 1 to 20 μm.

4. Film, as claimed in claim 1, wherein the film is multi-layered and has a symmetrical or an unsymmetrical structure, and wherein differently composed polyesters, or composed and non-composed polyesters, or polyesters of the same chemical compound, but with a different molecular weight and a different viscosity are combined by way of coextrusion.

5. Film, as claimed in claim 1, wherein the film mainly consists of a crystallizeable polyethylene terephthalate, a crystallizeable polyethylene naphthalate, or a mixture thereof, wherein the polyesters have a specific electrical melt resistance lying within a range from 1.5×10⁷ to 30×10⁷ Ω×cm.

6. Film, as claimed in claim 1, wherein the IV value of the polyester is within a range from 0.5 to 1.0 dl/g.

7. Process for the production of a film as claimed in claim 1 by way of extrusion, which comprises extruding a melted polyester material through a flat-film die (slot die) and placing it as a mainly amorphous prefilm on a quenching roll by using the electrical field of an electrode under high tension in the range from 4 to 8 kV and chilling it, reheating this prefilm thereafter and stretching it in the machine direction (=MD) and transverse direction (=TD), respectively in TD and in MD, respectively in TD and, again, in MD or in TD or again in MD and in TD, wherein the stretching temperatures are within the range from T_{g}+10 K to T_{g}+60 K, the length stretch (MD) ratio is set to a value within the range from 2 to 6, the transverse stretch (TD) ratio within the range from 2 to 5, and wherein the polyester raw material has a specific electrical melt resistance within the range from 1.5×10⁷ to 30×10⁷ Ω×cm.

8. Process as claimed in claim 7, wherein the ratio of the second length stretching is within the range from 1.1 to 3.

9. Process, as claimed in claim 7, wherein the stretched film is placed in a tenter frame for thermofixing purposes where it undergoes treatment at frame temperatures ranging from 150° C. to 250° C.

10. Process, as claimed in claim 9, wherein the thermofixed film is wound up after the thermofixing and wherein the speed for the winding process is set to a value of 340 m/min or higher.
